(19) United States
(12) Patent Application Publication
(10) Pub. No.: US 2012/0254089 A1
(43) Pub. Date: Oct. 4, 2012

(54) Vector throttling to control resource use in computer systems

(75) Inventors: Alfredo Alba, Morgan Hill, CA (US); Chad E. DeLuca, San Jose, CA (US); Vuk Ercegovac, Campbell, CA (US); Thomas D. Griffin, Campbell, CA (US); Jun Rao, San Jose, CA (US); Eugene J. Shekita, San Jose, CA (US); Asim V. Singh, San Jose, CA (US); Yuanyuan Tian, San Jose, CA (US); Kevin B. Wang, Mountain View, CA (US)

(73) Assignee: International Business Machines Corporation, Armonk, NY (US)

(21) Appl. No.: 13/077,586

(22) Filed: Mar. 31, 2011

(51) Int. Cl. G06N 5/02

(52) U.S. Cl. 706/47

(57) ABSTRACT

Embodiments of the invention relate to building a distributed reverse semantic index. In one general embodiment a plurality of documents are received with each document having at least one defined rule and or semantic. The documents are distributed among a plurality of nodes of a system. The documents are processed in a generally parallel fashion. Processing the documents includes processing text data of each of the document and breaking each document into fields to index the text data to create index data by deferring how to categorize the text data based upon the defined rule and or semantics. The indexed data is combined back together to create an indexer-agnostic semantic index including a plurality of the semantic index shards and to semantically classify the documents based on the index shards into groups based on document type to create the distributed reverse semantic index.

### BACKGROUND

The present invention relates generally to index build technology, and more particularly, to the generation of indexes for document searching in situations requiring semantic analysis as part of the search.

Indexing of documents is often used to reduce search times for document searches. Technology for index building generally aims for even distribution of the data that is indexed within a system. While the distributed computation of the search is powerful, it tends to break up the semantics of the data by assuming that the data is homogeneous. Homogeneity is a good assumption for the general text search problem. However, homogeneity presents a problem when semantic aggregation for analysis of data is needed, for instance, when specific data collections are relevant for a search. In general there are two solutions, collect specific indices relevant to those collections or develop complex aggregation and filtering data joiners. Both need increasingly complex queries, relying on intrinsically generated structured metadata.

Particular data stores may use specific indexing techniques, that are typically very close to the structure of the data being stored. General data storage systems may organize information based on common interest domains, meaning based on what the information of interest looks like, and what the information intends to model or represent. Often there is a mismatch between how data is queried to generate the searches and how it is stored in data sources.

### BRIEF SUMMARY

In one general embodiment, a method is disclosed for a system to build a distributed reverse semantic index. The method includes receiving a plurality of documents, with each document having at least one defined rule/semantic, distributing the plurality of documents among a plurality of nodes of a system, and processing the documents in a generally parallel fashion. Processing the documents comprises processing text data of each document, and breaking each document into fields to index the text data to create index data by deferring on how to categorize the text data based upon the at least one defined rules/semantic. The indexed data is then combined back together to create an indexer-agnostic semantic index including a plurality of semantic index shards. The method further includes semantically classifying the documents based on the index shards into groups based on document type to create the distributed reverse semantic index.

In another embodiment, a system is disclosed that is configured to build a distributed reverse semantic index. The system builds a distributed reverse semantic index that includes semantic index shards, with each semantic index shard including documents of a similar document type. To build the distributed reverse semantic index, a plurality of documents, each document having at least one defined rule/semantic are received. The plurality of documents are then distributed among a plurality of nodes of the system. The plurality of documents are then processed in a generally parallel fashion, where processing of the plurality of documents includes processing text data of each document of the plurality of documents and breaking each document into fields to index the text data to create index data by deferring on how to categorize the text data based upon the at least one defined rule/semantic. The system then recombines the indexed data to create an indexer-agnostic semantic index that includes a plurality of the semantic index shards. The system then semantically classifies the documents based on the index shards into groups based on document type, to create the distributed reverse semantic index that includes the indexer-agnostic index and the groups organized as the index shards.

In another embodiment, a computer program product is disclosed that comprises a computer readable medium having an embodiment of a computer usable program code. The computer usable program code is configured to receive a plurality of documents, with each document having at least one defined rule/semantic and distribute the plurality of documents among a plurality of nodes of the system. The computer usable program code is also configured to process the plurality of documents by the plurality of nodes in a generally parallel fashion, including process text data of each document of the plurality of documents and break each document into fields to index the text data to create index data by deferring on how to categorize the text data based upon the defined rules/semantics. The computer usable program code is further configured to recombine the indexed data to create an indexer-agnostic semantic index including a plurality of the semantic index shards. Finally, the computer usable program code is configured to semantically classify the documents based on the index shards into groups based on document type to create the distributed reverse semantic index.

### BRIEF DESCRIPTION OF THE SEVERAL VIEWS OF THE DRAWINGS

For a fuller understanding of the nature and advantages of the invention, as well as a preferred mode of use, reference should be made to the following detailed description read in conjunction with the accompanying drawings, in which:

FIG. 1 illustrates a representative hardware environment in accordance with one embodiment;

FIG. 2 is a block diagram of an embodiment of a system for building a distributed reverse semantic index and an embodiment of a method of operation of the system;

FIG. 3 is another embodiment of the system for building a distributed reverse semantic index of FIG. 2;

FIG. 4 is a diagram illustrating a shards of the Prior Art;

FIG. 5 is a diagram illustrating semantic shards of an embodiment of a system for building a distributed reverse semantic index;

FIGS. 6 and 7 are diagrammatic illustrations of an index builder and its workflow, in accordance with an embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

In one general embodiment, a method is disclosed for a system to build a distributed reverse semantic index. The method includes receiving a plurality of documents, with each document having at least one defined rule/semantic, distributing the plurality of documents among a plurality of nodes of a system, and processing the documents in a generally parallel fashion. Processing the documents comprises processing text data of each document, and breaking each document into fields to index the text data to create index data by deferring on how to categorize the text data based upon the at least one defined rules/semantic. The indexed data is then combined back together to create an indexer-agnostic semantic index including a plurality of semantic index shards. The method further includes semantically classifying the documents based on the index shards into groups based on document type to create the distributed reverse semantic index.

In another embodiment, a system is disclosed that is configured to build a distributed reverse semantic index. The system builds a distributed reverse semantic index that includes semantic index shards, with each semantic index shard including documents of a similar document type. To build the distributed reverse semantic index, a plurality of documents, each document having at least one defined rule/semantic are received. The plurality of documents are then distributed among a plurality of nodes of the system. The plurality of documents are then processed in a generally parallel fashion, where processing of the plurality of documents includes processing text data of each document of the plurality of documents and breaking each document into fields to index the text data to create index data by deferring on how to categorize the text data based upon the at least one defined rule/semantic. The system then recombines the indexed data to create an indexer-agnostic semantic index that includes a plurality of the semantic index shards. The system then semantically classifies the documents based on the index shards into groups based on document type, to create the distributed reverse semantic index that includes the indexer-agnostic index and the groups organized as the index shards.

In another embodiment, a computer program product is disclosed that comprises a computer readable medium having an embodiment of a computer usable program code. The computer usable program code is configured to receive a plurality of documents, with each document having at least one defined rule/semantic and distribute the plurality of documents among a plurality of nodes of the system. The computer usable program code is also configured to process the plurality of documents by the plurality of nodes in a generally parallel fashion, including process text data of each document of the plurality of documents and break each document into fields to index the text data to create index data by deferring on how to categorize the text data based upon the defined rules/semantics. The computer usable program code is further configured to recombine the indexed data to create an indexer-agnostic semantic index including a plurality of the semantic index shards. Finally, the computer usable program code is configured to semantically classify the documents based on the index shards into groups based on document type to create the distributed reverse semantic index.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

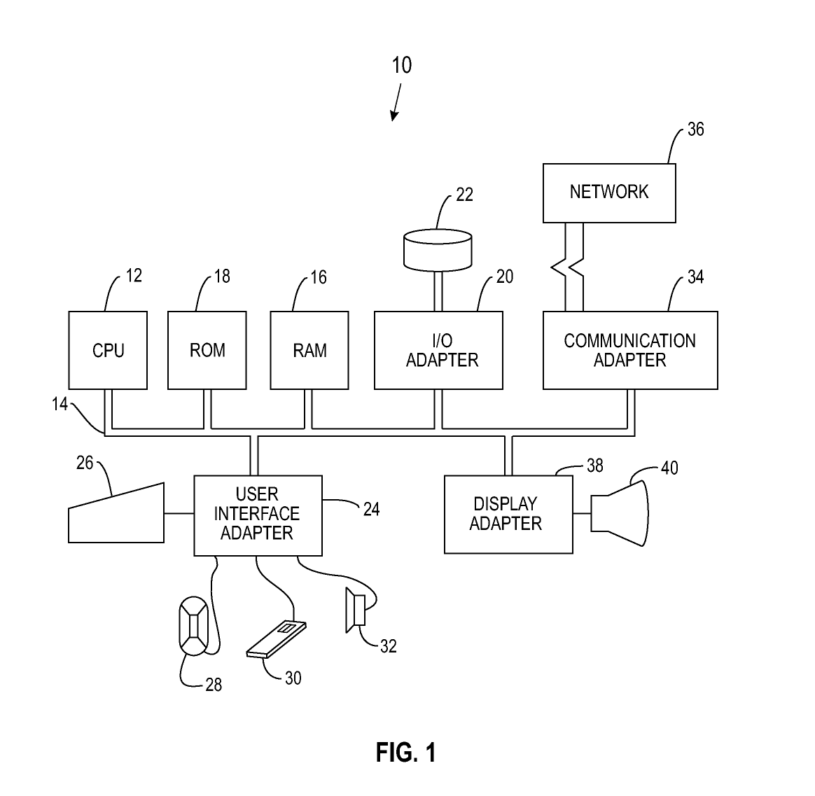

FIG. 1 shows a representative hardware environment associated with a user device 10 in accordance with one embodiment. The Figure illustrates a typical hardware configuration of a user device, or workstation 10, and/or server 10 that may include a central processing unit 12, such as a microprocessor, and a number of other devices interconnected via a system bus 14.

The workstation 10 shown in FIG. 1 includes a Random Access Memory (RAM) 16, Read Only Memory (ROM) 18, and an I/O adapter 20 for connecting peripheral devices such as disk storage units 22 to the bus 14. The workstation 10 also includes a user interface adapter 24 for connecting a keyboard 26, a mouse 28, a speaker 30, a microphone 32, and/or other user interface devices such as a touch screen and a digital camera (not shown) to the bus 14, a communication adapter 34 for connecting the workstation to a communication network 36 (e.g., a data processing network), and a display adapter 38 for connecting the bus 14 to a display device 40.

The workstation 10 may have resident thereon an operating system capable of running various programs. It will be appreciated that a preferred embodiment may also be implemented on any suitable platform or operating system. A preferred embodiment may be written using JAVA, XML, C, and/or C++ language, or other programming languages, along with an object oriented programming methodology. Object oriented programming (OOP), which has become increasingly used to develop complex applications, may be used.

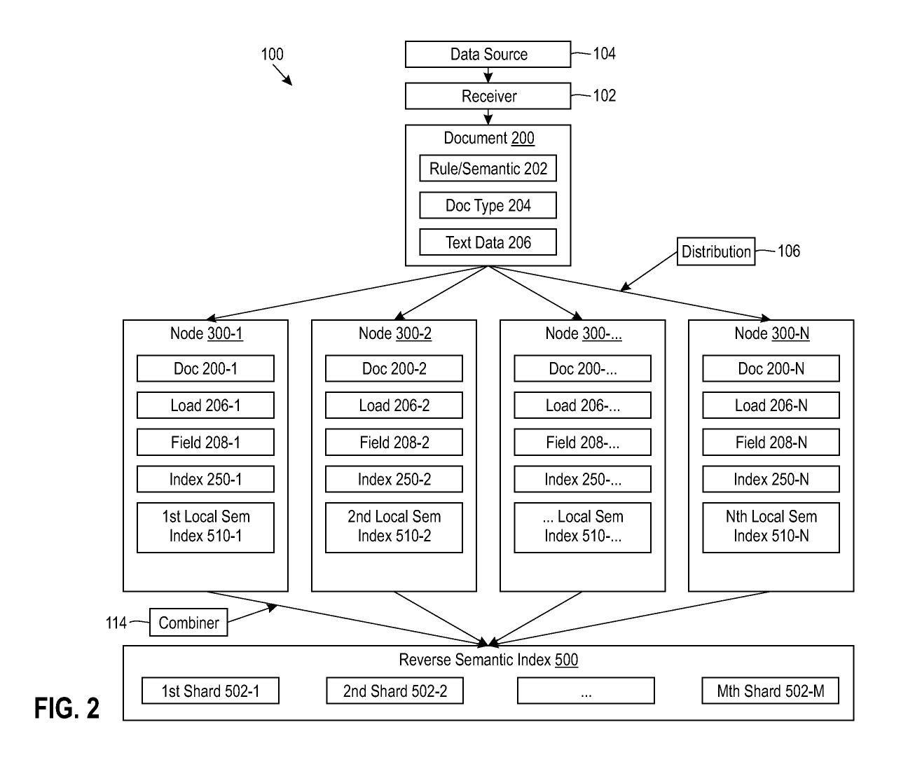

FIG. 2 illustrates a diagram of an embodiment of a computer-implemented method for a system 1000 to build a distributed reverse semantic index 500 containing semantic index shards 502-1, 502-2, and on to 502-M, where M is at least two. These semantic index shards 502-1 to 502-M are distributed among nodes 300-1 to 300-N, as local semantic indexes 510-1 in node 502-1, to local semantic index 510-N in node 502-N.

In one embodiment, the system 100 begins with a receiver 102 receiving documents 200 from an arbitrary data source 104. The specific nature of the data source 104 is not relevant. A distribution 106 then distributes the documents 200 among different nodes 300-1 to 300-N in the system 100, providing a generally balanced load 202-i for each node 202-i, where i ranges from 1 to N. The distributed documents 200-1 to 200-N are processed in a distributed parallel fashion, of each individual document 200 to create indexes 250.

For simplicity of discourse, consider an example of operating the node 300-1. A document 200-1 is processed along with the full text of the document 200-1 to create indexes 250-1. The document 200-1 is broken into fields 204-1, to handle different data types 206-1 appropriately. Additionally, semantic rules 202 are given special emphasis in order to enable the consistent classification of the data in the documents 200.

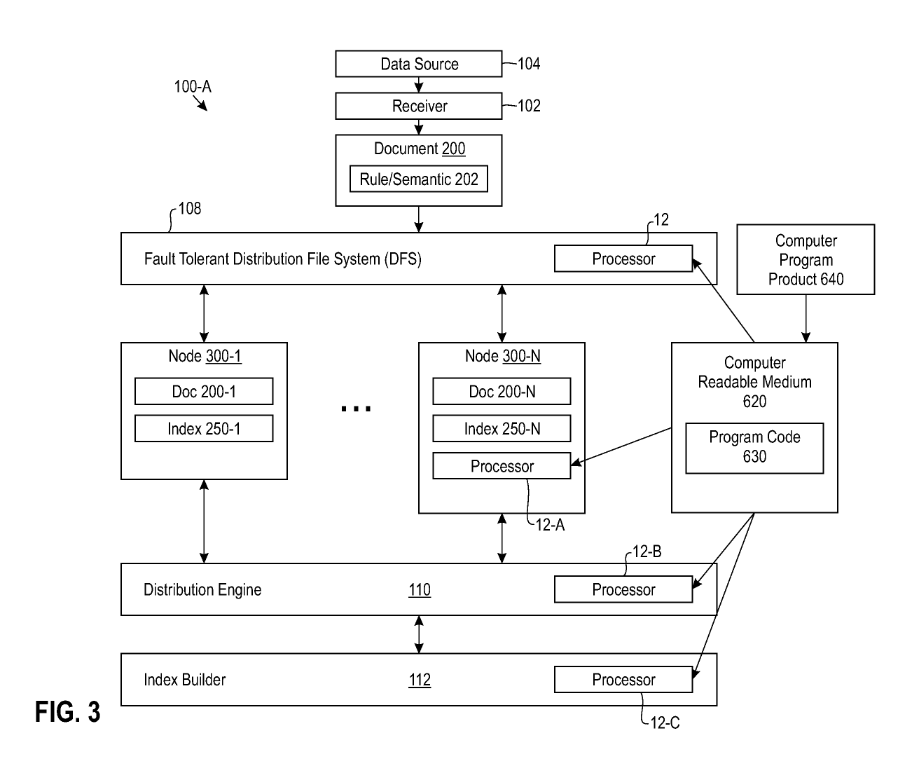

FIG. 3 illustrates an alternative embodiment system 100-A of the system 100 of FIG. 2. In this embodiment, the receiver 102 receives documents 200 from an arbitrary data source 104. Once received, the documents 200 reside in a fault tolerant Distributed File System (DFS) 108 making the documents 200-1 locally available to node 300-1, and on to 300-N. The nodes 300-1 to 300-N interact with a distribution engine 110 that coordinates access and use of an index builder 112 that may at least partly generate the indexes 250-1.

Referring to FIG. 2 and FIG. 3, in one general embodiment, the system 100 may be described as an implementation for building a distributed reverse semantic index 500, that includes semantic index shards 502-1, on to 502-M. Each semantic index shard 502-1 . . . to 502-M includes documents of a similar document type 104.

In one general embodiment, the system 100 may include the receiver 102 for receiving a plurality of the documents 200, with each document 200 having at least one defined rule/semantic 202. The system 100 may also include the distribution 106 distributing the plurality of the documents 200-1 to 200-N among a plurality of nodes 300-1 . . . to 300-N.

The system 100 may also include a processor, such as the central processing unit 12 described in FIG. 1 for processing the documents 200 in a generally parallel fashion. The processor 12 processes text data 206 of each of the document 200 and breaks each document 200, such as document 200-1, into fields 208 to index the text data 206 for creating index data 250-1. The index data 250-1 is created by deferring on how to categorize the text data 206 based upon the defined rules/semantics 202.

The system 100 may also include a combiner 114 for combining the indexed data 250-1 back together to create an indexer-agnostic semantic index 510-1 that includes a plurality of the semantic index shards 502-1 . . . to 502-M. In an alternative embodiment, the system 100 may semantically classifying the documents 200-1 . . . to 200-N based on the index shards 502-1 into groups based on document type 204 to create the distributed reverse semantic index 500.

In one embodiment, the DFS 108 may include the processor 12 that may embody at least part of the method, and may comprise the receiver 102 for receiving the documents 200 from the data source 104. The processor 12 that may also comprise the distribution 106 for distributing the documents 200.

In one embodiment, at least one of the nodes 300-1 to 300-N, such as the node 300-N, for example, may include a processor 12-A. The processor 12-A, may comprise a processor 12, such as the central processing unit 12 described in FIG. 1 and/or for may comprise another processor 12-A. In an exemplary embodiment, the second processor 12-A may also at least partly embody the method. For example, second processor 12-A may embody at least part of the distribution 106 for the documents 200 and for processing the documents 200-N. The second processor 12-A may further embody all or part of the combiner 114 for combining the indexed data 250-1 back together to create an indexer-agnostic semantic index 510-1 for semantically classifying the documents 200-1 . . . to 200-N based on the index shards 502-1.

In one embodiment, the distribution engine 110 may include another processor 12-B. The processor 12-B, may comprise a processor 12, such as the central processing unit 12 described in FIG. 1 and/or for may comprise another processor 12-B. The processor 12-B may implement at least part of the distribution 106 for distributing the documents 200. The processor 12-B also may implement at least part of the processing of the documents 200-N and/or at least part of the means for combiner 114 for combining the indexed data 250-1 back together to create an indexer-agnostic semantic index 510-1 for semantically classifying the documents 200-1 . . . to 200-N based on the index shards 502-1.

In one embodiment, the index builder 112 may also include a processor 12-C. The processor 12-C, may comprise a processor 12, such as the central processing unit 12 described in FIG. 1 and/or for may comprise another processor 12-C. The processor 12-C may implement that may implement at least part of the method, for instance, as at least part of the documents 200-N processing and/or at least part of the combiner 114 and/or semantically classify the documents 200-N.

Referring still to FIG. 2 and FIG. 3, a second phase of operating the system 100 involves combining the indexed data 250-1 back together in a semantically organized fashion. The documents 200-1 are semantically classified into logical groups based on defined rules 202. In one embodiment, exemplary defined rules 202, may include, but are not limited to, country of origin, topic, etc, or as complex as interrelation in between the document's metadata.

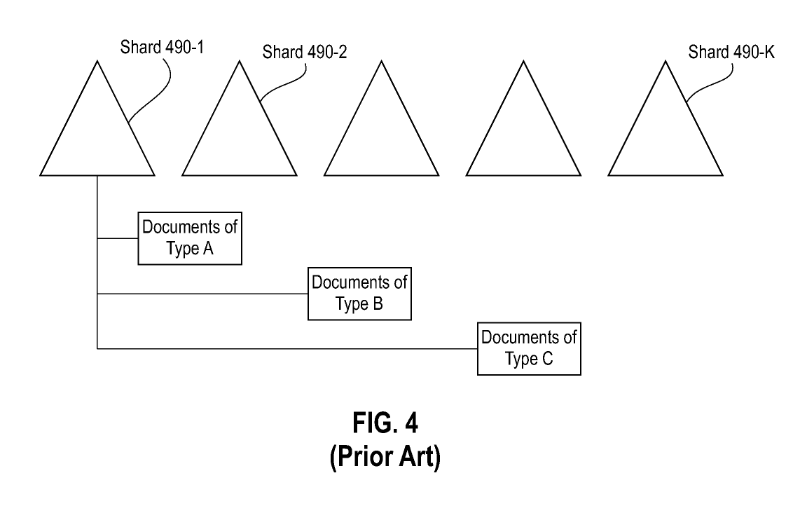

The indexed data 250-1 is combined back together based on these groups, with each group being used to build a semantic index shard 490 or set 492 of semantic index shards, as illustrated in Prior Art FIG. 4. Prior Art FIG. 4 illustrates an index built using a hash with evenly distributed shards 490-1, which may relate to any of several document types, shown here as Document types A, B and C.

Based on the knowledge acquired from the data source 104 the semantic index 502, or collections 500 of these semantic indexes 502, may be created based on the semantics 202 contained within the data source 104 itself. This way user queries can be optimized by quickly zeroing on to the data that is semantically relevant to the query at hand. The semantic index 502, or collection 500 of the semantic indexes 502, can be produced around classification and relationships of concepts and terms of specific domains of interest allowing search operations to be exhaustive on the realm of applicability, when appropriate, rather than across an entire corpus of disassociated documents. It must be noted that this does not prevent a corpus wide search to be used and traditional ranking algorithms to be applied, it rather enhances the indexing systems ability to leverage the semantics contained within the query itself.

Returning to FIG. 3, at least one of the processors 12, 12-A, 12-B, and/or 12-C may receive at least part of a program code 630 from a computer readable medium 620 that may be part of a computer program product 640.

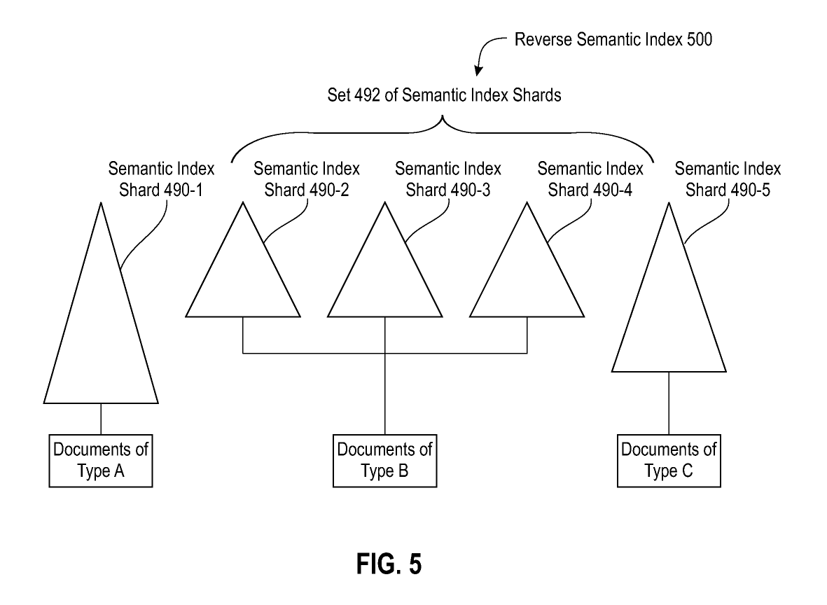

FIG. 5 illustrates the type of semantic index shards 490 the system 100 builds. The semantic index shards 490 do not need to be of equal size, as shown by the semantic index shard 490-1 being larger than any of the other semantic index shards 490-2 to 490-4. By organizing a semantic index shard 500-1 to relate to one specific document type, here shown as document type A, the distributed semantic indexes 510-1 are drawn only to relevant document types.

By indexing data using a semantic aggregation, much of the index 250-1 can be disregarded before the search takes place. This provides a comparable level of accuracy as searching the entire index, with only a subset of the indexed data having actually been searched. This can provide a strong performance improvement to the system 100 performing searches using the reverse semantic index 500.

The system 100 is independent of the index builder 112 and of any specific indexing process, procedure and/or rule base. The main logic of the system 100 is external to the actual indexing process, allowing any number of different index builders 112 to be used. Different indexing applications provide added functionality or other advantages over one another, so the ability to use the same process to build a semantic index in a distributed fashion with different indexers is beneficial. Additionally, the indexer-agnostic design of the system 100 allows it to be leveraged to test the performance of competing indexers.

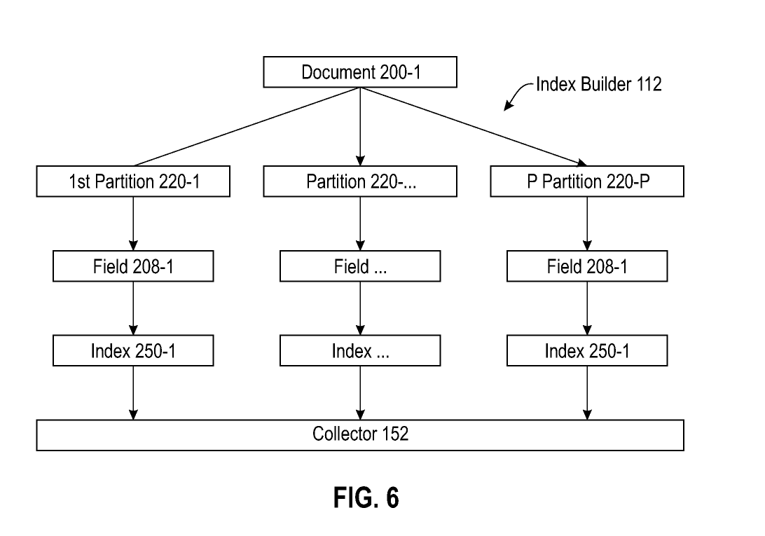

FIG. 6 illustrates some details of the index builder 112 of FIG. 3 showing a document 200-1 processed by one or more partition mechanisms 220-1 to 220-P, each may generate fields 208-1 and indexes 250-1, with the indexes 250 sent to a collector 152.

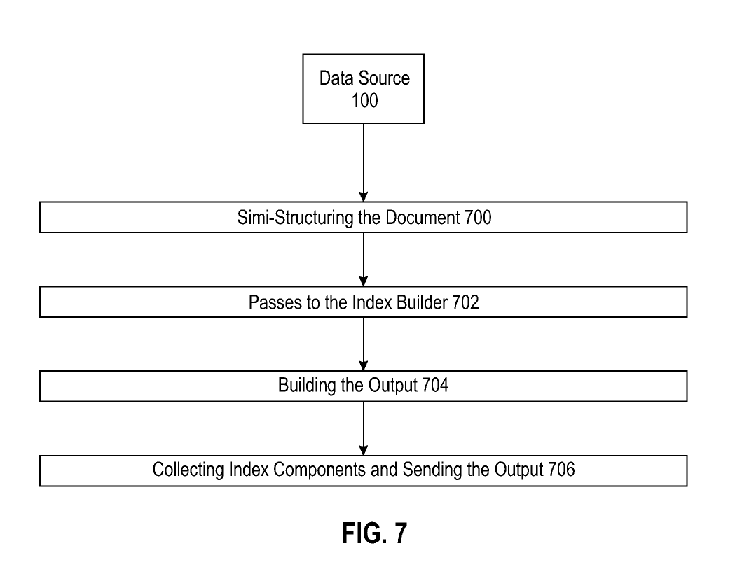

FIG. 7 illustrates some details of the workflow of the index builder 112 of FIG. 3 and FIG. 6, including semi-structuring 700 the document 200-1, followed by passes 704 to the builder 112, followed by building 704 the output and collecting 706 the index components 250-1 and sending the output.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
receiving a plurality of documents, each document having at least one defined rule/semantic;
distributing the plurality of documents among a plurality of nodes of a system;
processing the documents in a generally parallel fashion, processing the documents comprising:
processing text data of each document, and
breaking each document into fields to index the text data to create index data by deferring on how to categorize the text data based upon the at least one defined rules/semantic;
combining the indexed data back together to create an indexer-agnostic semantic index including a plurality of semantic index shards; and
semantically classifying the documents based on the index shards into groups based on document type to create the distributed reverse semantic index.

2. The method of claim 1 further comprising:
distributing the plurality of documents among the plurality of nodes for causing each node of the plurality of nodes to have a generally balanced load.

3. The method of claim 1, wherein each document of the plurality of documents has at least one defined rule/semantic that may be at least one of a topic, a country of origin and a metadata interrelationship.

4. The method of claim 1 further comprising:
receiving the plurality of the documents further comprises receiving the plurality of documents by a distributed file system.

5. The method of claim 4 further comprising:
receiving the plurality of documents by a fault tolerant version of the distributed file system.

6. The method of claim 1 further comprising:
processing the documents in a generally parallel fashion further comprises:
generally parallel processing the documents by at least two nodes of the plurality of nodes.

7. The method of claim 6 further comprising:
generally parallel processing the documents by at least one processor included in each of the at least two nodes.

8. The method of claim 1 further comprising:
using an index builder for combining the index data.

9. The method of claim 8 further comprising:
the index builder including at least one processor for combining by the index data.

10. A system, comprising:
means for building a distributed reverse semantic index including semantic index shards, each semantic index shard including documents of a similar document type, comprising:
means for receiving a plurality of documents, each document having at least one defined rule/semantic;
means for distributing the plurality of documents among a plurality of nodes of the system;
means for processing the documents in a generally parallel fashion, processing the documents including processing text data of each document of the plurality of documents and breaking each document into fields to index the text data to create index data by deferring on how to categorize the text data based upon the at least one defined rule/semantic;
means for recombining the indexed data to create an indexer-agnostic semantic index including a plurality of the semantic index shards; and
means for semantically classifying the documents based on the index shards into groups based on document type to create the distributed reverse semantic index including the indexer-agnostic index and the groups organized as the index shards.

11. The system of claim 10, wherein the means for distributing the plurality of documents further comprises:
means for distributing the plurality of documents to more than one node of the plurality of nodes for causing the more than one nodes to have a generally balanced load.

12. The system of claim 10, wherein each document has at least one defined rule/semantic that may be at least one of a topic, a country of origin, and a metadata interrelationship.

13. The system of claim 10, further comprising:
a processor operative to execute computer usable program code;
at least one of a network interface and a peripheral device interface for receiving user input; and
a computer usable medium having computer usable program code embodied therewith, the computer usable program code comprising:
computer usable program code configured to receive a plurality of documents, each document having at least one defined rule/semantic;
computer usable program code configured to distribute the plurality of documents among a plurality of nodes of the system;
computer usable program code configured to process the plurality of documents by the plurality of nodes in a generally parallel fashion, processing the plurality of documents including processing text data of each document and breaking each of the document into fields to index the text data to create index data by deferring on how to categorize the text data based upon the defined rules/semantics;
computer usable program code configured to recombine the indexed data to create an indexer-agnostic semantic index including a plurality of the semantic index shards; and
computer usable program code configured to semantically classify the documents based on the index shards into groups based on document type to create the distributed reverse semantic index.

14. The system of claim 10, wherein the means for receiving the plurality of the documents further comprises the means for receiving by a distributed file system the plurality of the documents.

15. The system of claim 14, wherein the means for receiving by the distributed file system the plurality of the documents further comprises receiving by a fault tolerant version of the distributed file system the plurality of the documents.

16. The system of claim 10, wherein the means for processing the documents in a generally parallel fashion further comprises generally parallel processing the documents by at least two nodes of the plurality of nodes.

17. The system of claim 16, wherein the means for generally parallel processing the documents by the at least two nodes of the plurality of nodes further comprises:
means for generally parallel processing the documents by at least one processor included in each of the at least two nodes of the plurality of nodes.

18. The system of claim 10, wherein the step combining the index data further comprises:
means for using an index builder to combine the index data.

19. The system of claim 18, wherein the index builder includes at least one processor for combining by the index data.

20. A computer program product, comprising: a computer readable medium having computer usable program code embodied therewith, the computer usable program code comprising:
computer usable program code configured to receive a plurality of documents, each document having at least one defined rule/semantic;
computer usable program code configured to distribute the plurality of documents among a plurality of nodes of the system;
computer usable program code configured to process the plurality of documents by the plurality of nodes in a generally parallel fashion, including process text data of each document of the plurality of documents and break each document into fields to index the text data to create index data by deferring on how to categorize the text data based upon the defined rules/semantics;
computer usable program code configured to recombine the indexed data to create an indexer-agnostic semantic index including a plurality of the semantic index shards; and
computer usable program code configured to semantically classify the documents based on the index shards into groups based on document type to create the distributed reverse semantic index.
